(19) United States
(12) Patent Application Publication
(10) Pub. No.: US 2005/0226649 A1
(43) Pub. Date: Oct. 13, 2005

(54) Image forming device

(75) Inventor: Takahiro Sasai, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/102,179

(22) Filed: Apr. 7, 2005

(30) Foreign Application Priority Data
Apr. 7, 2004 (JP) 2004-113474

(51) Int. Cl. G03G 21/00

(52) U.S. Cl. 399/99

(57) ABSTRACT

An image forming device includes a photoconductor, a charging device which charges a surface of the photoconductor, an exposing device which forms an electrostatic latent image on the charged surface of the photoconductor, a developing device which develops the electrostatic latent image by toner, a transfer device which transfers a developed toner image onto printing paper, a toner trapping member which traps the toner remaining on the photoconductor after a transfer process, and a potential control device. The potential control device controls a voltage to be impressed to the remaining toner trapping member so that a potential difference between a potential to be impressed to the remaining toner trapping member and a surface potential of the photoconductor corresponding to the remaining toner trapping member becomes substantially the same potential difference in a paper non-transport period and a paper transport period.

### BACKGROUND OF THE INVENTION

1. Field of the Invention

The present invention relates to an image forming device which can reliably trap toner remaining on the surface of a photoconductor.

2. Description of Related Art

In general, an electrophotographic image forming device is adopted in a copying machine, a facsimile machine or a printer. In the image forming device, an exposing unit forms an electrostatic latent image on a surface of a photoconductive drum charged by a charging unit. The electrostatic latent image is developed by a developing unit, which includes a developing roller carrying toner. A transfer unit transfers a developed toner image from the photoconductive drum onto printing paper. A fixing unit provided downstream of the transfer unit fixes the toner image onto the printing paper as a permanent image.

After the above-described transfer process, the toner, which was not transferred onto the printing paper, remains on the surface of the photoconductive drum. Since the untransferred remaining toner causes a deterioration in the image quality when forming a toner image on printing paper transported subsequently, the remaining toner is required to be removed. Therefore, according to a conventional technique, a remaining toner trapping member removes the remaining toner on the surface of the photoconductive drum. In this case, a bias potential of the remaining toner trapping member is controlled to be constant during a paper non-transport period (an idling period of the photoconductive drum) and a paper transport period of the printing paper.

According to the above-described conventional technique, before and after the printing paper passes and during a period when the printing paper passes, the transfer unit impresses a different bias voltage to the surface of the photoconductive drum. Therefore, unevenness is generated in the potential of the surface of the photoconductive drum. Thus, in case a constant potential is applied to the remaining toner trapping member as in the conventional technique, a potential difference between the constant potential and the potential of the surface of the photoconductive drum also becomes uneven. As a result, there is a drawback that the remaining toner trapping member cannot properly trap the remaining toner on the photoconductive drum.

It is experimentally known that a potential difference, which enables the remaining toner trapping member to preferably trap the remaining toner, falls within a prescribed range. Though experimentation, it has been confirmed that in case the potential difference is excessive, the toner trapped once by the remaining toner trapping member returns again to the photoconductive drum. In addition, in case the potential difference is large, when forming an image of a halftone pattern, striped density unevenness is prone to be generated.

### SUMMARY OF THE INVENTION

However, according to the present invention, a potential difference between a remaining toner trapping member and a surface potential of a photoconductor corresponding to the remaining toner trapping member is set substantially the same in a paper non-transport period and a paper transport period. Therefore, remaining toner on a surface of the photoconductor can be trapped reliably.

According to an aspect of the present invention, an exposing device forms an electrostatic latent image on the surface of a photoconductor charged by a charging device. A developing device develops the electrostatic latent image. A transfer device transfers a developed toner image onto printing paper. A remaining toner trapping member traps toner remaining on the photoconductor after a transfer process. An image forming device includes a potential control device, which impresses a voltage to the remaining toner trapping member so that a potential difference between a potential of the remaining toner trapping member and a surface potential of the photoconductor corresponding to the remaining toner trapping member becomes substantially the same potential difference in a paper non-transport period and a paper transport period.

According to another aspect of the present invention, the image forming device further includes a surface potential sensor, which detects the surface potentials of the photoconductor located downstream in the transfer process. The potential control device is preferable to control a potential to be impressed to the remaining toner trapping member and to control the potential difference to be substantially the same, in accordance with a detected value detected by the surface potential sensor.

According to another aspect of the present invention, the potential control device is preferable to control the potential to be impressed to the remaining toner trapping member and to control the potential difference to be substantially the same, in accordance with a fluctuation in the potential impressed by the transfer device in the paper non-transport period and the paper transport period.

According to another aspect of the present invention, the potential difference is preferable to be set within a range from 400V to 600V.

According to another aspect of the present invention, the potential control device is preferable to control the potential to be impressed to the remaining toner trapping member to be within a range of ±100V with respect to a center value of a set potential difference.

According to another aspect of the present invention, a re-charged potential of the photoconductor based on the potential impressed to the remaining toner trapping member by the potential control device is preferable to be set equal to or lower than a charged potential of the surface of the photoconductor after a charging process by the charging device.

According to the above-descried aspects of the present invention, the potential difference between the remaining toner trapping member and the surface of the photoconductor corresponding to the remaining toner trapping member is controlled to be substantially the same potential difference in the paper non-transport period and the paper transport period. Therefore, unevenness in the potential difference is suppressed. As a result, since the remaining toner trapping member can reliably trap the remaining toner on the surface of the photoconductor, an image quality improves.

### BRIEF DESCRIPTION OF THE SEVERAL VIEWS OF THE DRAWINGS

FIG. 1 is a timing chart for describing an operation for controlling a potential difference between a potential of a remaining toner trapping brush and a surface potential of a photoconductive drum.

FIG. 2 is a schematic cross-sectional view showing an image forming device according to an embodiment of the present invention.

### DETAILED DESCRIPTION OF THE INVENTION

An embodiment of the present invention will be described. Further, an embodiment to be described below is a preferable specific example for implementing the present invention. Therefore, there are various technical limitations in the description. However, unless explicitly stated in the following description to limit the present invention, the present invention shall not be limited to the embodiment.

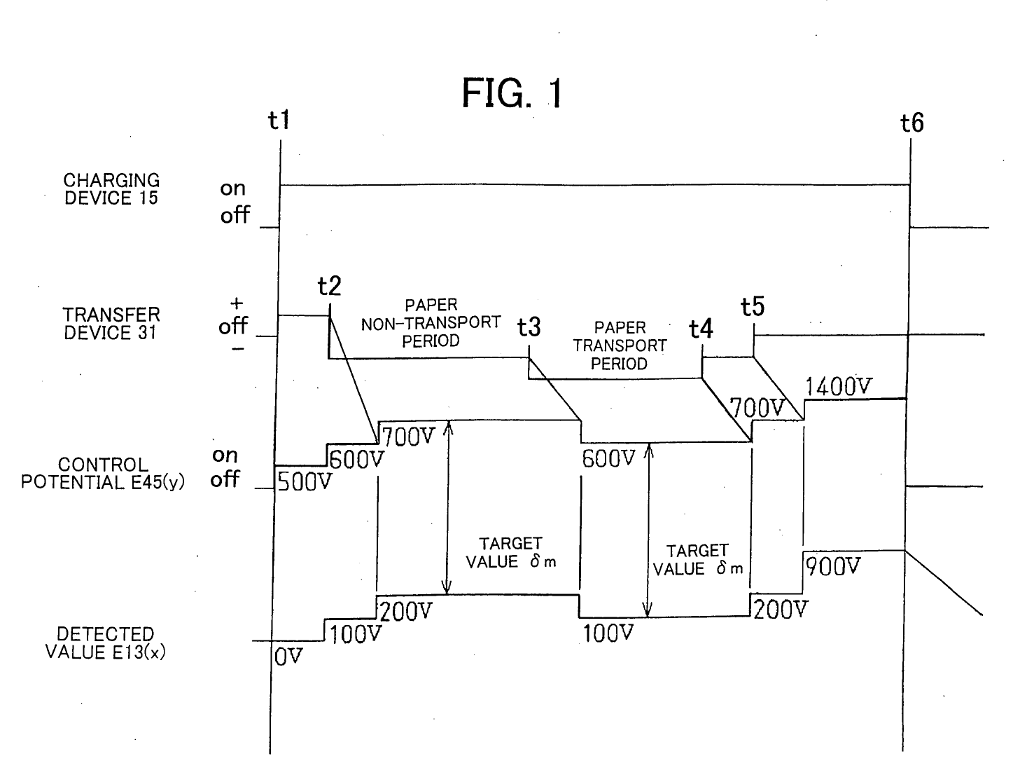

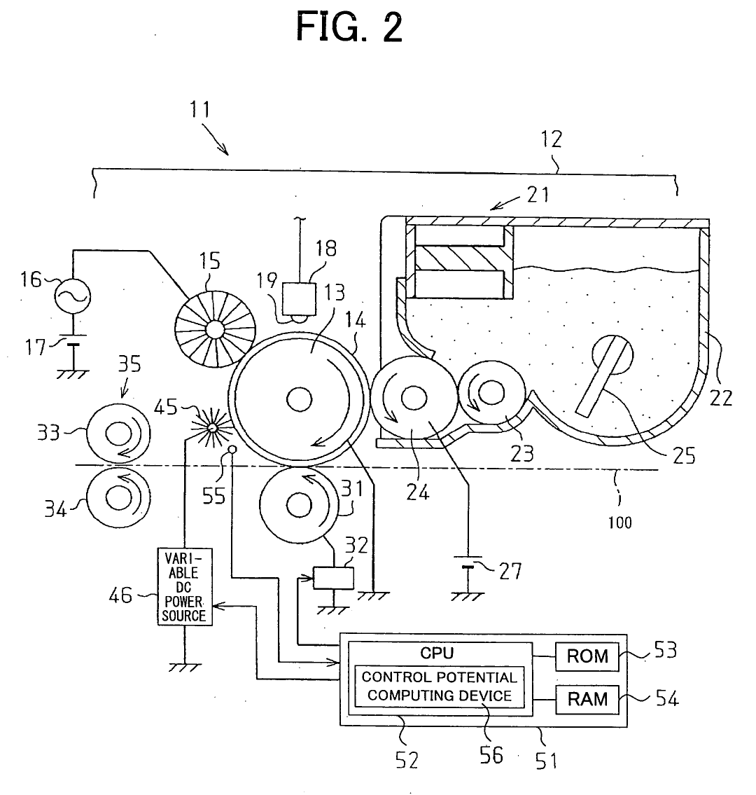

An electrophotographic image forming device according to an embodiment of the present invention is preferably adopted in a copying machine, a facsimile machine or a printer. The image forming device will be described with reference to FIG. 1 and FIG. 2. As shown in FIG. 2, an image forming device 11 includes a main body frame 12. A photoconductive drum 13 as a photoconductor is supported rotatably by the main body frame 12. A photoconductive layer 14 is formed on an outer circumferential surface of the photoconductive drum 13. The photoconductive drum 13 is set at a ground potential (for example, 0V). A charging device 15 is supported rotatably by the main body frame 12 so as to make contact with the photoconductive drum 13. The charging device 15 is configured with a brush roller on which an electrically conductive brush is implanted. A voltage of an alternating current and a direct current is impressed to the charging device 15 from an alternating current power source 16 and a direct current power source 17. The photoconductive layer 14 of the photoconductive drum 13 is uniformly charged positively at a prescribed potential (for example, +900V). An exposing device 18 is mounted on the main body frame 12 so as to be located at a prescribed position just above the photoconductive drum 13. A Light Emitting Diode (LED) array 19 is provided on a lower surface of the exposing device 18. The LED array 19 irradiates light onto the photoconductive layer 14 of the photoconductive drum 13. Accordingly, an electrostatic latent image is formed according to image data scanned by a document scanning device (not shown).

In the main body frame 12, a unitized developing device 21 is inserted in a manner capable of being replaced. The developing device 21 includes a toner case 22, a supply roller 23 and a developing roller 24. The supply roller 23 is provided in a lower part of the toner case 22 and a prescribed voltage is supplied to the supply roller 23 from a power source (not shown). The developing roller 24 is disposed at a lower opening of the toner case 22 so as to be located between the supply roller 23 and the photoconductive drum 13. An agitator 25 is supported rotatably in the toner case 22. The toner in the toner case 22 is agitated at all times by a rotation of the agitator 25 and the toner is maintained at an even density.

A prescribed voltage (for example, −300V or +300V) is supplied from a direct current power source 27 to the developing roller 24. The toner in the toner case 22 is transported by the supply roller 23 and a prescribed potential is applied to the toner by the developing roller 24. The toner adheres selectively to the electrostatic latent image by a potential difference (for example, +200V) between the applied potential (for example, +300V) and a potential of the electrostatic latent image formed on the photoconductive drum 13 (for example, +100V). A toner image is formed on the photoconductive drum 13 by the toner adhered on the electrostatic latent image.

In the main body frame 12, a roller-shaped transfer device 31 is disposed rotatably at a position just below the photoconductive drum 13. The photoconductive drum 13 makes close contact with the transfer device 31 and a transfer nip is formed. The transfer device 31 is controlled at a prescribed potential (for example, −3.7 kV or +900 V) by a power source 32. By the potential difference between a potential of the transfer device 31 and a potential of the toner image, the toner image on the photoconductive drum 13 is transferred onto printing paper 100 supplied from a printing paper supplying device (not shown).

In the main body frame 12, a heat fixing unit 35 is provided downstream of the photoconductive drum 13 in a printing paper feeding direction. The heat fixing unit 35 includes a heat roller 33 and a pressure roller 34. Therefore, when the printing paper 100 is fed into the heat roller 33 and the pressure roller 34, the toner image is heated and fixed onto the printing paper 100.

In the main body frame 12, a remaining toner trapping brush 45 is provided. The remaining toner trapping brush 45 is a brush made from an electrically conductive fiber. A variable direct current power source 46 for impressing a positive variable potential is connected to the remaining toner trapping brush 45. The remaining toner trapping brush 45 traps the remaining toner remaining on the photoconductive drum 13 after a transfer process. The trapped toner is disposed in a disposure tank by a removing unit (not shown).

A preferable fiber of the remaining toner trapping brush 45 is a metal fiber, a synthetic fiber of polycarbonate of carbon dispersion, nylon, polypropylene or the like, or a carbon fiber. A brush length is preferably 1 to 12 mm. A brush density is preferably 1 to 500,000 hairs per squared inches. A brush diameter is preferably 2.5 to 12.5 dtex. A brush resistance is preferably 10⁻² to 10¹² Ωcm. In the present embodiment, the brush length is 5 mm, the brush density is 100,000 hairs per squared inches, and the brush diameter is 6.7 dtex.

In the present embodiment, the above-described series of processes of charging, exposing and developing for the photoconductive drum 13, and transferring the toner image onto the printing paper 100 and fixing the toner image onto the printing paper 100 are one unit of a printing process.

The image forming device 11 includes a control device 51 having a computer for controlling various operations. The control device 51 includes a Central Processing Unit (CPU) 52, a Read Only Memory (ROM) 53, a Random Access Memory (RAM) 54, an input/output interface (not shown) and a power supply circuit (not shown). The CPU 52 computes various bias potentials necessary for a printing process in accordance with various data. The ROM 53 stores various operation programs. The RAM 54 is capable of reading and writing. The control device 51 outputs a potential control signal to the variable direct current power source 46 via a drive circuit (not shown). The control device 51 transmits a control signal to each power supply circuit of the charging device 15, the developing roller 24 and the transfer device 31, respectively, and controls a voltage to be impressed.

In the main body frame 12, a drum surface potential sensor 55 is provided for detecting a surface potential of the photoconductive drum 13. The drum surface potential sensor 55 detects the surface potential at the position between the transfer device 31 and the remaining toner trapping brush 45. A detected value detected by the drum surface potential sensor 55 is input to the control device 51.

A target value δm of a potential difference δ (E45-E13) between a potential E45 to be impressed to the remaining toner trapping brush 45 and a surface potential E13 of the photoconductive drum 13 is previously set in the ROM 53. The CPU 52 includes a control potential computing device 56. In accordance with a detected value E13(x) of the surface potential E13 of the photoconductive drum 13 detected by the drum surface potential sensor 55 and the target value δm of the potential difference δ (E45-E13) stored previously in the ROM 53, the control potential computing device 56 computes a control potential E45(y) to be impressed to the remaining toner trapping brush 45 so that the target value δm becomes constant (for example, +500V). A computing equation is set as follows: E45(y)=δm+E13(x)

Next, referring to the timing chart of FIG. 1, an operation of the above-described image forming device 11 will be described. In the present embodiment, the target value δm of the potential difference δ (E45-E13) is set at +500V.

When a power switch of the image forming device 11 is switched on, a warming-up operation is performed. Then, after a prescribed period of time elapses, the image forming device 11 becomes under a standby state. Under this state, when a print switch is switched on at time t1 of FIG. 1, the charging device 15 is switched on by a control signal from the control device 51 and the surface of the photoconductive drum 13 is charged, for example, to +900V. At the same time t1, the transfer device 31 is activated by a control signal from the control device 51 and a positive transfer bias potential of, for example, +1000V, is impressed to the photoconductive drum 13.

Meanwhile, when the power switch is switched on, the drum surface potential sensor 55 starts to detect the surface potential E13 of the photoconductive drum 13. When the detected value E13(x) is input to the control device 51, in accordance with the computing equation [E45(y)=δm+E13(x)], the control potential computing device 56 computes the control potential E45(y) to be impressed to the remaining toner trapping brush 45. The computed control potential E45(y) is transmitted from the control device 51 to the variable direct current power source 46 and a potential to be impressed actually to the remaining toner trapping brush 45 is determined. In FIG. 1, since the initial detected value E13(x) of the surface potential E13 is 0V, the control potential E45(y) is computed to be +500V from the abovementioned computing equation. The potential to be impressed actually to the remaining toner trapping brush 45 is controlled at +500V. When the detected value E13(x) of the surface potential E13 becomes +100V, the control potential E45(y) is computed to be +600V from the abovementioned computing equation. The potential to be impressed actually to the remaining toner trapping brush 45 is controlled at +600V.

Next, at time t2, the transfer device 31 is inverted from a positive potential (+1000V) to a negative potential (−1000V) and the photoconductive drum 13 idles to enter a paper non-transport period. Then, at the time t2, when the drum surface potential sensor 55 detects the surface potential E13 of the photoconductive drum 13 to be +200V, the control potential E45(y) is computed to be +700V from the abovementioned computing equation. The variable direct current power source 46 controls the potential impressed actually to the remaining toner trapping brush 45 at +700V.

Then, at time t3, which is a starting point of a paper transport period, the negative potential of the transfer device 31 increases further, for example, to −2000V, and the toner image is transferred onto the printing paper. In this case, an electric field generated by the transfer device 31 acts upon via the printing paper, which is a nonconductive body. By receiving this influence, the detected value E13(x) of the surface potential E13 of the photoconductive drum 13 decreases, for example, to +100V. Then, the drum surface potential sensor 55 detects the surface potential E13 of the photoconductive drum 13 to be +100V. Therefore, the control potential E45(y) is computed to be +600V from the abovementioned computing equation. The variable direct current power source 46 controls the potential impressed actually to the remaining toner trapping brush 45 at +600V.

Next, at time t4, when the paper transport period ends, the negative potential of the transfer device 31 decreases, for example, to −1500V. In this case, since the printing paper does not exist between the photoconductive drum 13 and the transfer device 31, the surface potential E13 of the photoconductive drum 13 increases to +200V. Therefore, the control potential E45(y) is computed to be +700V from the abovementioned computing equation. The variable direct current power source 46 controls the potential impressed actually to the remaining toner trapping brush 45 at +700V.

Furthermore, at time t5, the potential of the transfer device 31 changes from −1500V to zero potential. As a result, the surface potential E13 of the photoconductive drum 13 becomes +900V. Therefore, the control potential E45(y) is computed to be +1400V from the abovementioned computing equation. The variable direct current power source 46 controls the potential impressed actually to the remaining toner trapping brush 45 at +1400V.

Finally, at time t5, the printing process ends, the charging device 15 is switched off, and the potential stops being impressed to the photoconductive drum 13 and the remaining toner trapping brush 45.

According to the above-described embodiment of the present invention, the image forming device has the following effects. In the above-described embodiment, during the paper non-transport period indicated by the time t2 and the time t3 in FIG. 1 and also during the paper transport period indicated by the time t3 and the time t4, the potential difference δ (E45-E13) between the detected value E13(x) of the surface potential E13 of the photoconductive drum 13 corresponding to the remaining toner trapping brush 45 and the control potential E45(y) impressed actually to the remaining toner trapping brush 45 is controlled to be the same potential difference (for example, +500V). Accordingly, unevenness in the potential difference δ (E45-E13) is suppressed. As a result, the remaining toner trapping brush 45 can efficiently trap the remaining toner on the surface of the photoconductive drum 13. In addition, the toner trapped by the remaining toner trapping brush 45 can be prevented from returning to the photoconductive drum 13. Thus, an image quality of the printing paper 100 improves.

In the above-described embodiment, the drum surface potential sensor 55 detects the surface potential of the photoconductive drum 13. In accordance with the detected value E13(x) and the target value δm of the potential difference δ (E45-E13) stored previously in the ROM 53, the control potential E45(y) impressed to the remaining toner trapping brush 45 is computed from the computing equation so that the target value δm becomes constant. Thus, accuracy in the control of the target value δm of the potential difference can be improved.

Further, following variations of the above-described embodiment also fall within the scope of the present invention. As a first variation, the drum surface potential sensor 55 is omitted, and the potential to be impressed to the remaining toner trapping brush 45 according to a transfer potential is stored previously in a storage device. Then, in accordance with data fetched from a data table in the storage device, the potential of the remaining toner trapping brush 45 can be controlled. As a second variation, in place of the data table, by using a computing equation based on a transfer potential, a target potential difference and time stored previously in a storage unit, a control potential of the remaining toner trapping brush 45 can be computed.

As a third variation, since the target value δm of the potential difference δ changes by the temperature of the use environment of the image forming device, for example, the target value δm can be set within a range from +400V to +600V. As a fourth variation, the potential E45 to be impressed to the remaining toner trapping brush 45 can be controlled so that the potential E45 falls within a range of ±100V with respect to a center value of the set target value δm.

As a fifth variation, instead of the drum surface potential sensor 55, an impressed voltage of the transfer roller may be detected and the surface potential of the photoconductive drum 13 may be computed from a computing equation based on the detected value. As a sixth variation, a re-charged potential of the photoconductive drum 13 based on the potential impressed to the remaining toner trapping brush 45 by the variable direct current power source 46 can be set equal to or lower than a charged potential of the surface of the photoconductive drum 13 in a charging process by the charging device 15. In this case, there is an advantage that the re-charged potential does not have an adverse effect on the charging process.

As a seventh variation, a cleaner-less image forming device can be adopted. Further, the cleaner-less image forming device is a device which returns the toner trapped from the surface of the photoconductive drum 13 by the remaining toner trapping brush 45 to the photoconductive drum 13, collects the toner by the developing roller 24 and reuses the toner.

As an eight variation, as the storage device of various data and the operation programs, in place of the ROM 53 and the RAM 54, another storage device such as a hard disk and a magnetic recording medium may be used.

1. An image forming device, comprising:
a photoconductor;
a charging device which charges a surface of the photoconductor;
an exposing device which forms an electrostatic latent image on the charged surface of the photoconductor;
a developing device which develops the electrostatic latent image by toner;
a transfer device which transfers a developed toner image onto printing paper;
a remaining toner trapping member which traps the toner remaining on the photoconductor after a transfer process; and
a potential control device which controls a voltage to be impressed to the remaining toner trapping member so that a potential difference between a potential to be impressed to the remaining toner trapping member and a surface potential of the photoconductor corresponding to the remaining toner trapping member becomes substantially a same potential difference in a paper non-transport period and a paper transport period.

2. The image forming device according to claim 1, further comprising:
a surface potential sensor which detects the surface potential of the photoconductor downstream in the transfer process;
wherein the potential control device controls a potential to be impressed to the remaining toner trapping member and controls the potential difference at substantially a same potential, in accordance with a detected value detected by the surface potential sensor.

3. The image forming device according to claim 1, wherein in accordance with a fluctuation of the potential impressed by the transfer device in the paper non-transport period and the paper transport period, the potential control device controls the potential to be impressed to the toner trapping member and controls the potential difference at substantially the same potential.

4. The image forming device according to claim 1, wherein the potential difference is set within a range from 400V to 600V.

5. The image forming device according to claim 4, wherein the potential control device controls the potential to be impressed to the remaining toner trapping member to be within a range of ±100V with respect to a center value of a set potential difference.

6. The image forming device according to claim 1, wherein a re-charged potential of the photoconductor based on the potential to be impressed to the remaining toner trapping member by the potential control device is set equal to or lower than a charged potential of the surface of the photoconductor charged by the charging device.

7. An image forming method, comprising the steps of:
forming an electrostatic latent image on a charged surface of a photoconductor;
developing the electrostatic latent image by toner;
transferring a developed toner image onto printing paper;
trapping toner remaining on the photoconductor after transferring by a remaining toner trapping member; and
controlling a potential difference between a potential to be impressed to the remaining toner trapping member and a surface potential of the photoconductor corresponding to the remaining toner trapping member at substantially a same potential difference in a paper non-transport period and a paper transport period.

8. The image forming method according to claim 7, further comprising the steps of:
detecting the surface potential of the photoconductor downstream from transferring; and
controlling the potential to be impressed to the remaining toner trapping member and controlling the potential difference to be substantially the same, in accordance with a detected value.

9. The image forming method according to claim 7, further comprising the step of controlling the potential to be impressed to the remaining toner trapping member and controlling the potential difference to be substantially the same, in accordance with a fluctuation of the potential impressed in the paper non-transport period and the paper transport period.

10. The image forming method according to claim 7, further comprising the step of setting the potential difference within a range from 400V to 600V.

11. The image forming method according to claim 10, further comprising the step of controlling the potential to be impressed to the remaining toner trapping member to be within a range of ±100V with respect to a center value of a set potential difference.

12. The image forming method according to claim 7, further comprising the step of setting a re-charged potential of the photoconductor based on the potential to be impressed to the remaining toner trapping member to be equal to or lower than a charged potential of the surface of the photoconductor in a charging process by a charging device, in case a potential difference between the potential to be impressed to the remaining toner trapping member and the surface potential of the photoconductor corresponding to the remaining toner trapping member is set at substantially the same potential difference in the paper non-transport period and the paper transport period.

13. An image forming device, comprising:
a photoconductor;
a charging device which charges a surface of the photoconductor;
an exposing device which forms an electrostatic latent image on the charged surface of the photoconductor;
a developing device which develops the electrostatic latent image by toner;
a transfer device which transfers a developed toner image onto printing paper;
a remaining toner trapping member which traps the toner remaining on the photoconductor after a transfer process; and
means for controlling a voltage to be impressed to the remaining toner trapping member so that a potential difference between a potential to be impressed to the remaining toner trapping member and a surface potential of the photoconductor corresponding to the remaining toner trapping member becomes substantially a same potential difference in a paper non-transport period and a paper transport period.

14. The image forming device according to claim 13, further comprising:
a surface potential sensor which detects the surface potential of the photoconductor downstream in the transfer process;
wherein the means for controlling controls a potential to be impressed to the remaining toner trapping member and controls the potential difference at substantially a same potential, in accordance with a detected value detected by the surface potential sensor.

15. The image forming device according to claim 13, wherein in accordance with a fluctuation of the potential impressed by the transfer device in the paper non-transport period and the paper transport period, means for controlling controls the potential to be impressed to the toner trapping member and controls the potential difference at substantially the same potential.

16. The image forming device according to claim 13, wherein the potential difference is set within a range from 400V to 600V.

17. The image forming device according to claim 16, wherein the means for controlling controls the potential to be impressed to the remaining toner trapping member to be within a range of ±100V with respect to a center value of a set potential difference.

18. The image forming device according to claim 13, wherein a re-charged potential of the photoconductor based on the potential to be impressed to the remaining toner trapping member by the means for conrolling is set equal to or lower than a charged potential of the surface of the photoconductor charged by the charging device.

19. The image forming device according to claim 1, wherein the toner remaining trapping member is a metal fiber.

20. The image forming device according to claim 13, wherein the toner remaining trapping member is a metal fiber.
